(19) United States
(12) Patent Application Publication
(10) Pub. No.: US 2025/0031272 A1
(43) Pub. Date: Jan. 23, 2025

(54) METHOD, DEVICE AND COMPUTER READABLE MEDIUM FOR COMMUNICATION

(71) Applicant: NEC CORPORATION, Tokyo (JP)

(72) Inventors: Xiaohong ZHANG, Beijing (CN); Gang WANG, Beijing (CN)

(73) Assignee: NEC CORPORATION, Tokyo (JP)

(21) Appl. No.: 18/718,902

(22) PCT Filed: Dec. 14, 2021
(86) PCT No.: PCT/CN2021/138049

§ 371 Date: Jun. 12, 2024

(51) Int. Cl. H04W 76/28; H04W 52/14; H04W 72/0453

(52) U.S. Cl. CPC H04W 76/28; H04W 52/143; H04W 72/0453

(57) ABSTRACT

Embodiments of the present disclosure relate to methods, devices and computer readable media for communication. According to embodiments of the present disclosure, a terminal device receives, from a network device, a plurality of DRX configurations for a serving cell or a serving cell group. The terminal device detects a power saving indication signal within a monitoring window. The terminal device starts an on-duration timer based on the detection of the power saving indication signal. In this way, it saves power at the terminal device.

### TECHNICAL FIELD

Embodiments of the present disclosure generally relate to the field of telecommunication, and in particular, to methods, devices and computer storage media for communication.

### BACKGROUND

Several technologies have been proposed to improve communication performances. Discontinuous reception (DRX) is a method that is employed in various wireless technologies to allow a terminal device to turn its receiver off during periods of inactivity. DRX can be employed in both RRC idle mode and RRC connected mode. In communication systems, the terminal device is configured to use DRX to reduce power consumption and the terminal devices are expected to monitor one paging occasion (PO) per DRX cycle. In RRC idle mode, the DRX cycle is based on the paging cycle, as the terminal device expects to only receive paging messages. In RRC connected mode, the terminal device needs to monitor physical downlink control channel (PDCCH) search space for possible indication of incoming traffic.

### SUMMARY

In general, embodiments of the present disclosure provide methods, devices and computer storage media for communications.

In a first aspect, there is provided a method of communication. The method comprises: receiving, at a terminal device and from a network device, a plurality of discontinuous reception (DRX) configurations for a serving cell or a serving cell group; determining, at the terminal device, a set of target DRX timers or a set of target DRX configurations of the plurality of DRX configurations; and monitoring, at the terminal device, a physical downlink control channel (PDCCH) based on the set of target DRX timers or the set of target DRX configurations.

In a second aspect, there is provided a terminal device. The terminal device comprises a processor and a memory coupled to the processor. The memory stores instructions that when executed by the processor, cause the terminal device to perform acts comprising: receiving, at a terminal device and from a network device, a plurality of discontinuous reception (DRX) configurations for a serving cell or a serving cell group; determining, at the terminal device, a set of target DRX timers or a set of target DRX configurations of the plurality of DRX configurations; and monitoring, at the terminal device, a physical downlink control channel (PDCCH) based on the set of target DRX timers or the set of target DRX configurations.

In a third aspect, there is provided a method of communication. The method comprises: receiving, at a terminal device and from a network device, a plurality of discontinuous reception (DRX) configurations for a serving cell or a serving cell group; detecting, at the terminal device, a power saving indication signal within a monitoring window, wherein the monitoring window is associated with one or more DRX configurations of the plurality of DRX configurations; and starting a DRX on-duration timer of the plurality of DRX configurations based on the detection of the power saving indication signal.

In a fourth aspect, there is provided a method of communication. The method comprises: receiving, at a terminal device and from a network device, a plurality of discontinuous reception (DRX) configurations for a serving cell or a serving cell group; receiving, at a terminal device and from a network device, a configuration for a search space set group (SSSG) for each DRX configuration; and monitoring, at the terminal device, a physical downlink control channel (PDCCH) based on one or more search space set group (SSSG) within an overlapped on-duration window of the plurality of DRX configurations.

In a fifth aspect, there is provided a terminal device. The terminal device comprises a processor and a memory coupled to the processor. The memory stores instructions that when executed by the processor, cause the terminal device to perform acts comprising: receiving, at a terminal device and from a network device, a plurality of discontinuous reception (DRX) configurations for a serving cell or a serving cell group; detecting, at the terminal device, a power saving indication signal within a monitoring window, wherein the monitoring window is associated with one or more DRX configurations of the plurality of DRX configurations; and starting a DRX on-duration timer of the plurality of DRX configurations based on the detection of the power saving indication signal.

In a sixth aspect, there is provided a terminal device. The terminal device comprises a processor and a memory coupled to the processor. The memory stores instructions that when executed by the processor, cause the terminal device to perform acts comprising: receiving, at a terminal device and from a network device, a plurality of discontinuous reception (DRX) configurations for a serving cell or a serving cell group; receiving, at a terminal device and from a network device, a configuration for a search space set group (SSSG) for each DRX configuration; and monitoring, at the terminal device, a physical downlink control channel (PDCCH) based on one or more search space set group (SSSG) within an overlapped on-duration window of the plurality of DRX configurations.

In a seventh aspect, there is provided a method of communication. The method comprises: transmitting, at a network device, a plurality of discontinuous reception (DRX) configurations for a serving cell or a serving cell group; and transmitting a configuration of a search space set group (SSSG) for each DRX configuration.

In an eighth aspect, there is provided a network device. The network device comprises a processor and a memory coupled to the processor. The memory stores instructions that when executed by the processor, cause the network to perform acts comprising: transmitting, at the network device, a plurality of discontinuous reception (DRX) configurations for a serving cell or a serving cell group; and transmitting a configuration of a search space set group (SSSG) for each DRX configuration.

In a ninth aspect, there is provided a computer readable medium having instructions stored thereon. The instructions, when executed on at least one processor, cause the at least one processor to perform the method according to the first, third or fourth, or seventh aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications between devices in accordance with some embodiments of the present disclosure;

FIG. 3 illustrates a schematic diagram of DRX configurations in accordance with some embodiments of the present disclosure;

FIG. 4 illustrates a schematic diagram of DRX configurations in accordance with some embodiments of the present disclosure;

FIG. 5 illustrates a schematic diagram of DRX configurations in accordance with some embodiments of the present disclosure;

FIG. 6 illustrates a schematic diagram of DRX configurations in accordance with some embodiments of the present disclosure;

FIG. 7 illustrates a signaling flow for communications between devices in accordance with some embodiments of the present disclosure;

FIG. 8 illustrates a schematic diagram of DRX configurations in accordance with some embodiments of the present disclosure;

FIG. 9 illustrates a schematic diagram of DRX configurations in accordance with some embodiments of the present disclosure;

FIG. 10 illustrates a signaling flow for communications between devices in accordance with some embodiments of the present disclosure;

FIG. 11 illustrates a schematic diagram of DRX configurations in accordance with some embodiments of the present disclosure;

FIG. 12 illustrates a flow chart of an example method of communication implemented at a terminal device in accordance with some embodiments of the present disclosure;

FIG. 13 illustrates a flow chart of an example method of communication implemented at a network device in accordance with some embodiments of the present disclosure;

FIG. 14 illustrates a flow chart of an example method of communication implemented at a terminal device in accordance with some embodiments of the present disclosure;

FIG. 15 illustrates a flow chart of an example method of communication implemented at a terminal device in accordance with some embodiments of the present disclosure;

FIG. 16 illustrates a flow chart of an example method of communication implemented at a network device in accordance with some embodiments of the present disclosure;

FIG. 17 illustrates a flow chart of an example method of communication implemented at a network device in accordance with some embodiments of the present disclosure; and

FIG. 18 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As mentioned above, DRX has been proposed. When terminal device is configured with a DRX configuration for a serving cell, terminal device will monitor PDCCH in each DRX cycle based on the DRX configuration. drx-on-duration Timer defines a duration at the beginning of a DRX cycle during which the terminal device should monitor the PDCCH, also called on-duration window. After on-duration window in the DRX cycle is duration for opportunity for DRX during which the terminal device may not monitor the PDCCH and sleep for battery saving purposes. If terminal device receives a PDCCH indicating a new data transmission (DL or UL) on the serving cell, terminal device will start or restart drx-InactivityTimer of the DRX configuration in the first symbol after the end of the PDCCH reception and monitors the PDCCH in every subframe while the drx-InactivityTimer is running. The term “DRX” used herein refers to a method used in mobile communication to conserve the battery of the mobile device. The mobile device and the network negotiate phases in which data transfer occurs. During other times the device turns its receiver off and enters a low power state. The “resources” used herein comprises resources in frequency domain and resources in time domain which can be used for transmission between communication devices. The term “on-duration” used herein refers to a time period during which the terminal device is able to monitor a downlink channel. The term “opportunity for DRX” or “off-duration” used herein refers to a time period during which the terminal device does not monitor the downlink channel and does not receive data or control information on the downlink channel. The term “DRX cycle” used herein comprises an on-duration window during which the terminal device should monitor the downlink channel and a duration window for opportunity for DRX during which the terminal device can skip reception of downlink channels.

An import topic is power saving, since many extended reality (XR) devices are power limited. The term “XR” used herein can comprise virtual reality (VR) and augmented reality (AR). XR applications in reality can comprise multiple traffic flows which likely have different traffic characteristics, for example, different flows may have different periodicity, delay requirements, data packet. Regarding periodicity, the periodicity for video may be 16.67 ms, the periodicity for audio may be 20 ms, and the periodicity for data stream may be 10 ms. Regarding data rate, the data rate for video may be larger than 10 Mbps, the data rate for audio/data may be about 1 Mbps.

When UE is configured with dual connectivity (DC), two DRX configurations can be configured for the UE and each DRX configuration is for a cell group. For XR service with multiple traffic flows with different traffic characteristics, if follow current mechanism that only one DRX configuration can be configured for UE in a cell or cell group, UE will have less time to sleep.

Therefore, solutions on multiple DRX configurations for a UE in a cell or cell group for matching multiple XR flows with different traffic characteristics to save UE power are needed. According to embodiments of the present disclosure, a terminal device receives, from a network device, a plurality of DRX configurations for a serving cell or a serving cell group. The terminal device monitors a PDCCH based on one or more DRX configurations of the plurality of DRX configurations. In this way, it saves power at the terminal device.

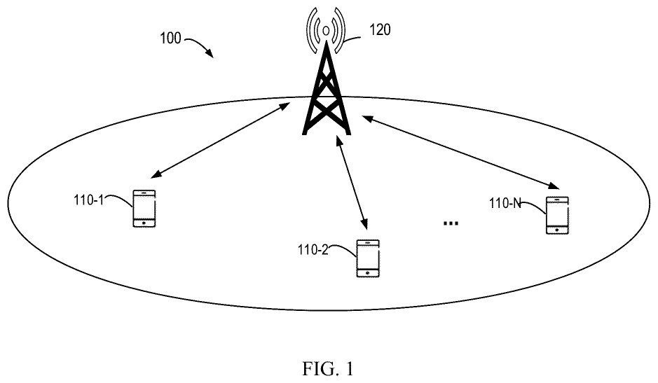

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device 120. In the communication system 100, the network devices 120 and the terminal devices 110 can communicate data and control information to each other. The numbers of devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at NR IIoT/URLLC. Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

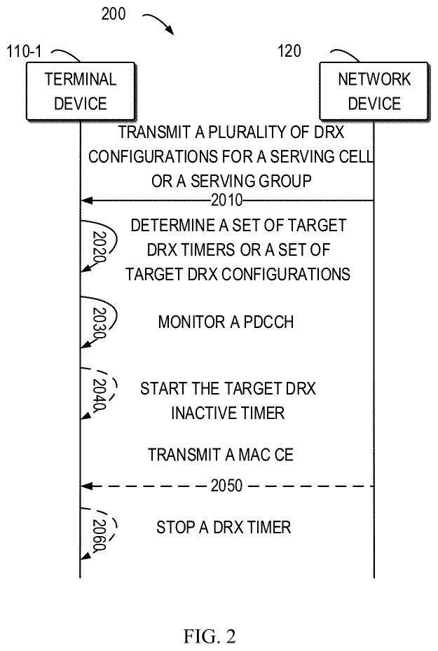

FIG. 2 shows a signaling chart illustrating process 200 among devices according to some example embodiments of the present disclosure. Only for the purpose of discussion, the process 200 will be described with reference to FIG. 1. The process 200 may involve the terminal device 110-1 and the network device 120 in FIG. 1. It should be noted that the process 200 is only an example not limitation.

The network device 120 transmits 2010 a plurality of DRX configurations for a serving cell or a serving cell group to the terminal device 110-1. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

The terminal device 110-1 determines 2020 a set of target DRX timers or a set of target DRX configurations from the plurality of DRX configurations. The set of target DRX timers can comprise one or more of: the DRX on-duration timer, the DRX inactivity timer, or the DRX retransmission timer.

The terminal device 110-1 monitors 2030 a PDCCH based on set of target DRX timers or the set of target DRX configurations. Example embodiments of the determination of the set of target DRX timers and/or the set of target DRX configurations are described with the following figures.

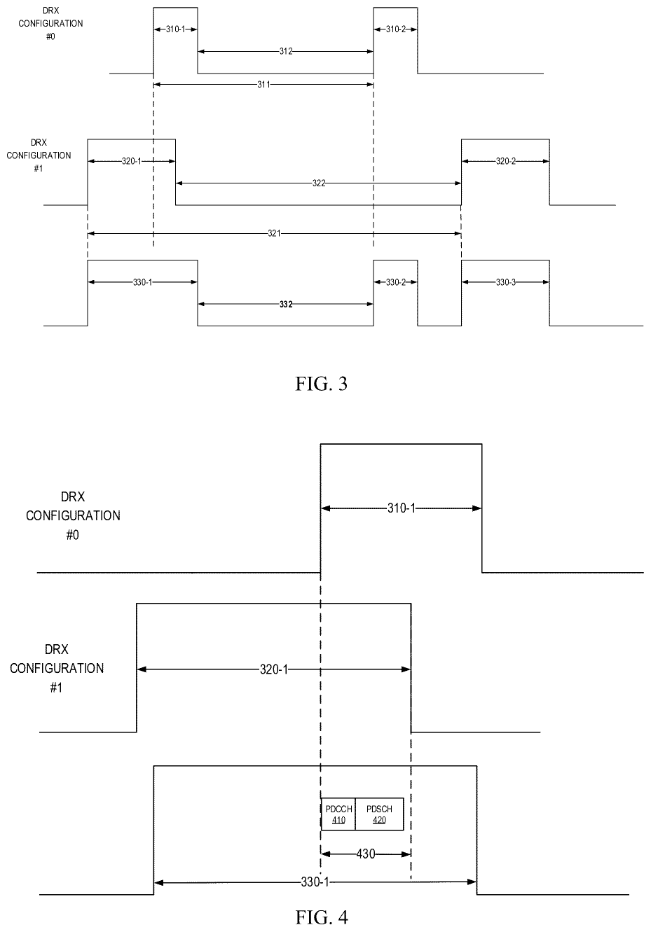

In some embodiments, the plurality of DRX configurations can be running independently. That is to say, the terminal device 110-1 can maintain DRX timers of the plurality of DRX configurations simultaneously. The terminal device 110-1 can monitor the PDCCH according to the set of target DRX timers of the set of DRX configurations separately. In this case, the terminal device 110-1 can monitor the PDCCH when one or more the set of target DRX timers is running. In other words, when multiple DRX configurations are configured, the active time for serving cells in a DRX group includes the time while:—drx-onDurationTimer or drx-InactivityTimer configured of each of the multiple DRX configurations for the DRX group is running; or—drx-RetransmissionTimerDL or drx-RetransmissionTimerUL of each of the multiple DRX configurations is running on any Serving Cell in the DRX group; or—ra-ContentionResollutionTimer or msgB-ResponseWindow (as described in clause 5.1.4a) is running; or—a Scheduling Request is sent on PUCCH and is pending; or—a PDCCH indicating a new transmission addressed to the C-RNTI of the MAC entity has not been received after successful reception of a Random Access Response for the Random Access Preamble not selected by the MAC entity among the contention-based Random Access Preamble. In this way, it is easy to implement. Referring to FIG. 3, FIG. 3 shows a schematic diagram of the DRX configurations.

As shown in FIG. 3, the terminal device 110-1 can have two DRX configurations, DRX configuration #0 and DRX configuration #1. There is an on-duration time window 310-1 and a duration time 312 for opportunity for DRX within one DRX cycle 311. The DRX on-duration timer of the DRX configuration #0 is running within the on-duration time window 310-1 and on-duration time window 310-2. Similarly, there is an on-duration time window 320-1 and a duration time 322 for opportunity for DRX within one DRX cycle 321. The DRX on-duration timer of the DRX configuration #1 is running within the on-duration time window 320-1 and 320-2. In this case, the terminal device 110-1 can monitor the PDCCH within the duration 330-1, which is determined based on on-duration time window 310-1 and on-duration time window 320-1. The terminal device 110-1 can also monitor the PDDCH within the duration 330-2 which corresponds to the on-duration time window 310-2 of the DRX configuration #0. The terminal device 110-1 may monitor the PDCCH within the duration 330-3 which corresponds to the on-duration time window 320-2 of the DRX configuration #1. The terminal device 110-1 may sleep within the duration 332.

In some embodiments, the on duration time windows of more than one DRX configuration can be overlapped. In this situation, the terminal device 110-1 may receive the PDCCH scheduling new transmission in such overlapped on-duration time windows. The terminal device 110-1 may start 2040 a target DRX inactivity timer of a DRX configuration from the plurality of DRX configurations. In this case, it is unclear for the terminal device to start the related DRX timer(s) associated which DRX configuration when a PDCCH for scheduling new data transmission is received in the overlapped time window. The phrase “start a timer” used herein can referring to start the timer for the first time or restart the timer. For example, as shown in FIG. 4, the on-duration time window 310-1 and the on-duration time window 320-1 are overlapped. The terminal device 110-1 can receive the PDCCH 410 in the overlapped on-duration time window 430. The PDCCH 410 may schedule the PDSCH 420. The terminal device 110-1 may start/restart a DRX inactivity timer of the DRX configuration #0 or the DRX configuration #1. It should be noted that FIG. 4 only shows an example not limitation.

The terminal device 110-1 may select the target DRX inactivity timer based on predetermined information. In some embodiments, the terminal device 110-1 may start the target DRX inactivity timer with a smallest/smaller value. For example, if the value of the DRX inactivity timer of the DRX configuration #0 is 2 ms and the value of the DRX inactivity time of the DRX configuration #1 is 4 ms, the terminal device 110-1 may start the DRX inactivity timer of the DRX configuration #0. Alternatively, the terminal device 110-1 may start the target DRX inactivity with a largest/larger value. In this case, if the value of the DRX inactivity timer of the DRX configuration #0 is 2 ms and the value of the DRX inactivity time of the DRX configuration #1 is 4 ms, the terminal device 110-1 may start the DRX inactivity timer of the DRX configuration #1. In some embodiments, the terminal device 110-1 may start the target DRX inactivity timer with a highest/higher DRX configuration index. In this case, the terminal device 110-1 may start the DRX inactivity timer of the DRX configuration #1. Alternatively, the terminal device 110-1 may start the target DRX inactivity timer with a lowest/lower DRX configuration index. In this case, the terminal device 110-1 may start the DRX inactivity timer of the DRX configuration #0. In some other embodiments, the terminal device 110-1 may start the target DRX inactivity timer with a shortest/shorter periodicity. For example, the periodicity of the DRX configuration #0 is shorter than the periodicity of DRX configuration #1, the terminal device 110-1 may start the DRX inactivity timer of the DRX configuration #0. Alternatively, the terminal device 110-1 may start the target DRX inactivity timer with a longest/longer periodicity. For example, the periodicity of the DRX configuration #0 is shorter than the periodicity of DRX configuration #1, the terminal device 110-1 may start the DRX inactivity timer of the DRX configuration #1. In some embodiments, the terminal device 110-1 may start the target DRX inactivity timer associated with a XR flow with lowest/lower priority. For example, the priority of XR flow #0 associated with the DRX configuration #0 is lower the priority of XR flow #1 associated with DRX configuration #1, the terminal device 110-1 may start the DRX inactivity timer of the DRX configuration #0. Alternatively, the terminal device 110-1 may start the target DRX inactivity timer associated with a XR flow with highest/higher priority. For example, the priority of XR flow #0 associated with the DRX configuration #0 is lower than the priority of XR flow #1 associated with DRX configuration #1, the terminal device 110-1 may start the DRX inactivity timer of the DRX configuration #1.

In some embodiment, the network device 120 may transmit a RRC configuration to the terminal device 110-1. In this case, if the RRC configuration indicates an index of the target DRX configuration, the terminal device 110-1 may select the DRX inactivity timer of the target DRX configuration based on the RRC configuration. Only as an example, if the RRC configuration indicates the index of the DRX configuration #0, the terminal device 110-1 may start the DRX inactivity timer of the DRX configuration #0.

Alternatively, the network device 120 may transmit downlink control information (DCI) to the terminal device 110-1. The terminal device 110-1 may select the DRX inactivity timer of the target DRX configuration based on the received DCI. In this case, in some embodiments, the DCI may explicitly indicate the target DRX configuration. For example, the DCI carried in the scheduling PDCCH may comprise a field to indicate the index of the target DRX configuration. In this situation, the terminal device 110-1 may start the DRX inactivity timer of the target DRX configuration. In some other embodiments, the DCI may implicitly indicate the target DRX configuration. For example, the DCI may comprise traffic flow information associated with the target DRX configuration. In this situation, the terminal device 110-1 may start the DRX inactivity timer of associated with the traffic flow.

In some embodiments, the terminal device 110-1 may select the DRX inactivity timer of the target DRX configuration based on the DCI and RRC configuration. For example, the RRC configuration may indicate a table of the plurality of DRX configurations and the DCI may indicate the index of the target DRX configuration. In this case, the terminal deice 110-1 may start the DRX inactivity timer of the target DRX configuration based on the DCI and the RRC configuration. Embodiments of determining the target timer or target DRX configuration can also be applied to DRX retransmission timer determination.

In some embodiments, the terminal device 110-1 may receive a MAC control element (CE) carrying a DRX command from the network device 120 within running time of the plurality of DRX timers of the plurality of DRX configurations. The term “DRX command” used herein can also refer to a long DRX command. In some embodiments, the plurality of DRX timers can be DRX on-duration timers. Alternatively, the plurality of DRX timers can be DRX inactivity timers. Alternatively, the plurality of DRX timers can be DRX inactivity timers and DRX on-duration timers. For example, as shown in FIG. 4, the on-duration time window 310-1 and the on-duration time window 320-1 are overlapped when drx-onDurationTimers of DRX configuration #0 and DRX configuration #1 are running simultaneously. The terminal device 110-1 can receive the MAC CE in the overlapped on-duration time window 430. In this case, it is unclear for the terminal device that the received DRX command MAC CE is applied for which DRX configuration. It should be noted that FIG. 4 only shows an example not limitation. In some embodiments, the MAC CE can indicate the index of the target DRX configuration. For example, the MAC CE may comprise a field for indicating the index of the target DRX configuration. In this case, the terminal device 110-1 can apply the DRX command for the target DRX configuration. The terminal device 110-1 can stop the DRX on-duration timer and/or the DRX inactivity timer of the target DRX configuration. For example, if the terminal device 110-1 receives a long DRX command MAC CE with the index of the DRX configuration #0, the terminal device 110-1 may stop the DRX on-duration timer and/or the DRX inactivity timer of the DRX configuration #0. In this situation, the running time of the DRX configuration #1 will not be impacted. Alternatively, if the terminal device 110-1 receives the DRX command MAC CE with the index of the DRX configuration #0, the terminal device 110-1 may stop the DRX on-duration timer and/or the DRX inactivity timer of the DRX configuration #0. In this case, in some embodiments, if the DRX configuration #0 has a short DRX cycle, the terminal device 110-1 may change to use the short DRX cycle of DRX configuration index #0.

Alternatively, the terminal device 110-1 can apply the DRX command for the plurality of DRX configurations. The terminal device 110-1 can stop all of the DRX on-duration timer and/or the DRX inactivity timer of the plurality of DRX configurations. For example, the terminal device 110-1 may stop all the running DRX on-duration timers and/or the DRX inactivity timers of the DRX configuration #0 and the DRX configuration #1. In some embodiments, running timers of the DRX configuration #0 and the DRX configuration #1 can be the DRX on-duration timers. Alternatively, the running timers of the DRX configuration #0 and the DRX configuration #1 can be the DRX inactivity timers. In other embodiments, one of the running timer can be the DRX on-duration timer and the other running timer can be the DRX inactivity timer.

In some other embodiments, the network device 120 may transmit, to the terminal device 110-1, DCI which schedules a PDSCH transmission for a traffic flow. In this case, if the terminal device 110-1 receives the MAC CE associated with the PDSCH carrying the DRX command within running time of the plurality of DRX timers of the plurality of DRX configurations, the terminal device 110-1 may cause the DRX on-duration timer and/or the DRX inactivity timer of the target DRX configuration associated with the traffic flow to be stopped.

In some other embodiments, the plurality of DRX configurations can be running jointly. For example, the plurality of DRX configurations can comprise a first DRX configuration which comprises a first DRX on-duration timer and a second DRX configuration which comprises a second DRX on-duration timer. In this case, the terminal device 110-1 can monitor the PDCCH during running time of the first DRX on-duration timer. If a time offset between an ending symbol of the first DRX timer and a start symbol of the second DRX timer does not exceed a predetermined or configured gap, the terminal device 110-1 will skip the second DRX timer. In other words, the terminal device 110-1 will not start the second DRX timer. In other words, when multiple DRX configurations are configured, if drx-onDurationTimer of the first DRX configuration is running and time gap between the ending time of drx-onDurationTimer of the first DRX configuration and the start time of drx-onDurationTimer of the second DRX configuration is smaller than the Gap value m, the terminal device will not start the drx-onDurationTimer of the second DRX configuration in this DRX cycle. The Active Time for Serving Cells in a DRX group includes the time while:—drx-onDurationTimer or drx-InactivityTimer configured for the DRX group is running; or—drx-RetransmissionTimerDL or drx-RetransmissionTimerUL is running on any Serving Cell in the DRX group; or—ra-ContentionResolutionTimer or msgB-ResponseWindow is running; or—a Scheduling Request is sent on PUCCH and is pending; or—a PDCCH indicating a new transmission addressed to the C-RNTI of the MAC entity has not been received after successful reception of a Random Access Response for the Random Access Preamble not selected by the MAC entity among the contention-based Random Access Preamble. In this way, it provides more sleep time for the terminal device and there are no overlapped on-duration time windows generated.

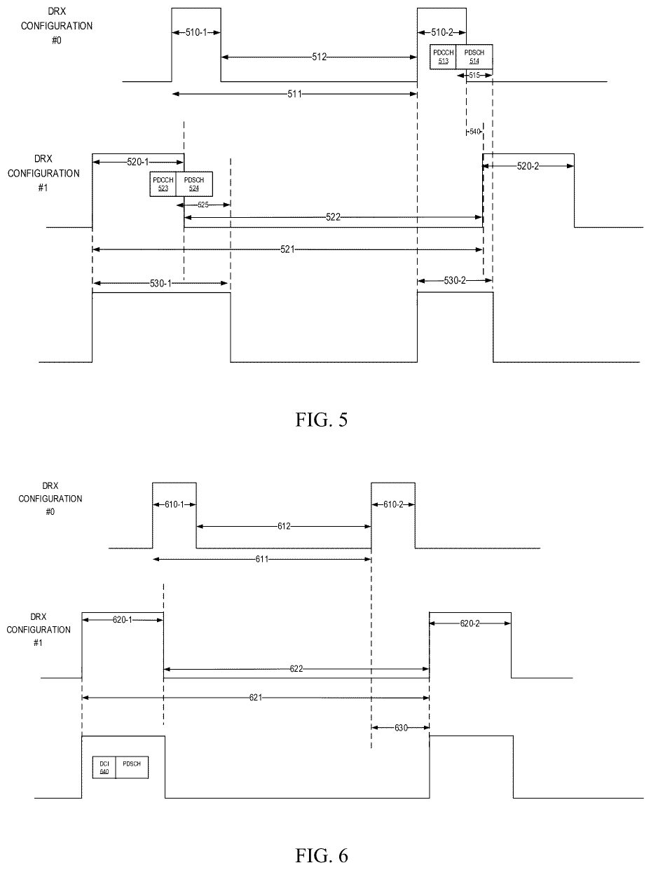

Referring to FIG. 5, FIG. 5 shows a schematic diagram of the DRX configurations. As shown in FIG. 5, the terminal device 110-1 can have two DRX configurations, DRX configuration #0 and DRX configuration #1. There is an on-duration time window 510-1 and a duration 512 for opportunity for DRX within one DRX cycle 511. The DRX on-duration timers of the DRX configuration #0 can run within the on-duration time windows 510-1 and 510-2. Similarly, there is an on-duration time window 520-1 and a duration 522 for opportunity for DRX within one DRX cycle 521. The DRX on-duration timers of the DRX configuration #1 can run within the on-duration time windows 520-1 and 520-2. In this case, as shown in FIG. 5, the terminal device 110-1 can receive the PDCCH 523 within the on-duration time window 520-1. The terminal device 110-1 can start the DRX inactivity timer 525 of DRX configuration #1 in the first symbol after the end of the PDCCH reception 523. Since the start symbol of the DRX on-duration timer of DRX configuration #0 is located in the on-duration window of DRX configuration #1, which means the time offset between two DRX on-duration timers of the two DRX configurations is 0. The terminal device 110-1 may not start the DRX on-duration timer of the DRX cycle 511. Since the network device 120 can extend the active time (e.g., 530-1) for the terminal device 110-1 by configuring suitable DRX inactive timer, the data transmission of XR flow associated with DRX configuration #0 can be ensured. Similarly, the terminal device 110-1 can receive the PDCCH 513 within the on-duration time window 510-2. The terminal device 110-1 can start the DRX inactivity timer 515 of DRX configuration #0 in the first symbol after the end of the PDCCH reception 513. If the time offset 540 between the ending symbol of the on-duration time window 510-2 and the start symbol of the on-duration time window 520-2 does not exceed the predetermined gap, the terminal device 110-1 may not start the on-duration timer for the on-duration time window 520-2. Alternatively, if the time offset 540 between the ending symbol of the on-duration time window 510-2 and the start symbol of the on-duration time window 520-2 exceeds the predetermined gap, the terminal device 110-1 may start the on-duration timer for the on-duration time window 520-2.

In some other embodiments, the plurality of DRX configurations can be running jointly. For example, the plurality of DRX configurations can comprise a first DRX configuration which comprises a first DRX on-duration timer and a second DRX configuration which comprises a second DRX on-duration timer. If start time of the second DRX on-duration timer is located in the running time of the first DRX on-duration timer, the terminal device 110-1 may monitor PDCCH based on a third DRX on-duration timer, which is generated based on the first DRX on-duration timer and the second DRX on-duration timer. The start time of the third DRX on-duration timer is same with the first DRX on-duration timer which has an earlier start point. The ending time of the third DRX on-duration timer is same with the DRX on-duration timer among the first and second DRX on-duration timer which has the latest ending point.

In some embodiments, one of the plurality of DRX configurations can be running. In other words, the terminal device 110-1 can maintain timers of one DRX configuration. The terminal device 110-1 can switch the active DRX configuration among the plurality of DRX configurations. For example, the plurality of DRX configurations can comprise a first DRX configuration which comprises a first set of DRX timers and a second DRX configuration which comprises a second set of DRX timers. In this case, the terminal device 110-1 can monitor the PDCCH during running time of the first set of DRX timers. In some embodiments, if the terminal device 110-1 receives DCI comprising a switch indication from the network device 120, the terminal device 110-1 may switch to the second set of DRX timers. Alternatively, if a switch timer at the terminal device 110-1 expires, the terminal device 110-1 may switch to the second set of DRX timers. In this case, the terminal device 110-1 then can monitor the PDCCH during running time of the second set of DRX timers. In this way, it provides more sleep time for the terminal device and there are no overlapped on-duration time windows.

Referring to FIG. 6, FIG. 6 shows a schematic diagram of the DRX configurations. As shown in FIG. 6, the terminal device 110-1 can have two DRX configurations, DRX configuration #0 and DRX configuration #1. There is an on-duration time window 610-1 and a duration 612 for opportunity for DRX within one DRX cycle 611. The DRX on-duration timers of the DRX configuration #0 can run within the on-duration time windows 610-1 and 610-2. Similarly, there is an on-duration time window 620-1 and a duration 622 for opportunity for DRX within one DRX cycle 621. The DRX on-duration timers of the DRX configuration #1 can run within the on-duration time windows 620-1 and 620-2. When the DRX configuration #1 is running, the terminal device 110-1 can receive the DCI 640 within the on-duration time window 620-1. The DCI 640 can comprise the switch indication which indicates whether the running/active DRX configuration is switched to another DRX configuration for the next cycle. If the switch indication comprises “0”, the terminal device 110-1 cannot switch to the DRX configuration #0 and the terminal device 110-1 can start the DRX on-duration timer of the on-duration time window 620-2. Alternatively, if the switch indication comprises “1”, the terminal device 110-1 can switch to the DRX configuration #0 and the terminal device 110-1 can start the DRX on-duration timer of the on-duration time window 610-2. It should be noted that values of the switch indication are only examples not limitations. The delay 630 can be tolerated by the delay requirement of the traffic flow of the DRX configuration #0.

As mentioned above, the terminal device 110-1 may switch to the second set of DRX timers based on a switch timer. In this case, the switch timer can be configured via RRC configuration. The value of the switch timer can be based on the periodicity of traffic flows.

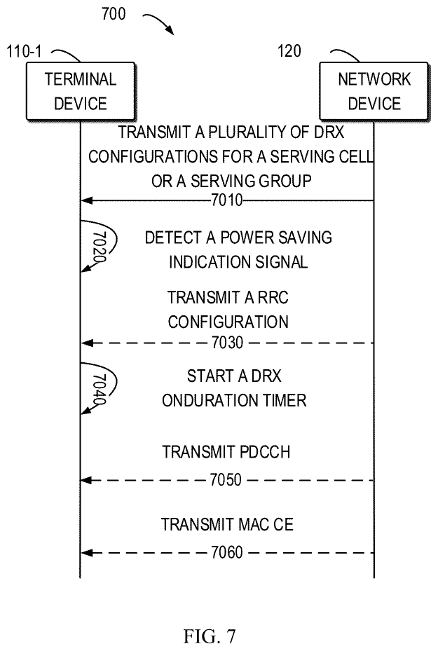

FIG. 7 shows a signaling chart illustrating process 700 among devices according to some example embodiments of the present disclosure. Only for the purpose of discussion, the process 700 will be described with reference to FIG. 1. The process 700 may involve the terminal device 110-1 and the network device 120 in FIG. 1. It should be noted that the process 700 is only an example not limitation.

The network device 120 transmits 7010 a plurality of DRX configurations for a serving cell or a serving cell group to the terminal device 110-1. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

The terminal device 110-1 detects 7020 a power saving indication signal within a monitoring window. The monitoring window is associated within one or more DRX configurations of the plurality of DRX configurations. In some embodiments, the power saving indication signal can be a wake up signal (WUS). Alternatively, the power saving indication signal can be a low power WUS. In some other embodiments, the power saving indication signal can be a PDDCH skipping indication which is included in DCI. The DCI which comprises the PDDCH skipping indication can indicate that the terminal device can skip monitoring the PDCCH for certain duration. The DCI also indicates the length of the certain duration in time domain. Such duration can comprise a set of symbols, a set of slots or a set of DRX cycles. It should be noted that the power saving indication signal can also be any proper signals. Only for the purpose of illustrations, embodiments of the present disclosure are described with the reference to power saving indication signal being WUS hereinafter.

A wake-up signal (WUS) indication conveyed by DCI signaling with a DCI format 2_6, which is scrambled by a power saving radio network temporary identifier (PS-RNTI), can be used to inform the terminal device whether or not to start the DRX on-duration timer for the next DRX cycle for potential data scheduling. A WUS detection window (search space set) can be configured before the on-duration of a DRX configuration for PDCCH monitoring for WUS, and one or more PDCCH occasions in the WUS window should be detected. The terminal device can detect the WUS DCI before DRX on-duration. If the wake-up indication sets to “1”, the terminal device should start the DRX on-duration timer. Otherwise, the terminal device does not need to start the timer.

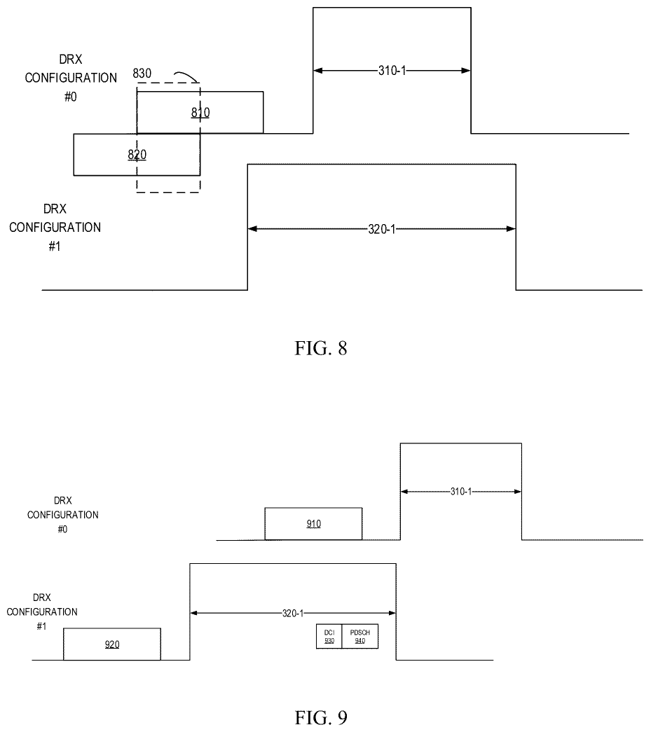

Referring to FIG. 8, the WUS window 810 of the DRX configuration #0 and the WUS window 820 of the DRX configuration #1 can be overlapped with each other. The terminal device 110-1 may receive the WUS within the overlapped portion 830. It is unclear for the terminal device that the received WUS is used for indicating whether to start the DRX on-duration timer of which DRX configuration. It may degrade the transmission performance of XR flow when network device sends the PDCCH for scheduling data transmission of the XR flow but terminal device doesn't detect the PDCCH due to the WUS miss detection. In some embodiments, the network device 120 may transmit 7030 a RRC configuration to the terminal device 110-1. For example, the RRC configuration may indicate the target DRX configuration. In this case, if the received WUS indication sets to “1”, the terminal device 110-1 may start 7040 the DRX on-duration timer of the target DRX configuration based on the RRC configuration. In this way, the terminal device can differentiate the DRX on-duration timer of which DRX configuration to run when the WUS detection windows are overlapped.

Alternatively, different frequency domain resources (for example, control resource set (CORESET)) can be configured for WUS monitoring occasion of different DRX configurations. In this case, the terminal device 110-1 may determine a frequency domain resource of the monitoring window. The terminal device 110-1 may determine a target DRX configuration based on the frequency domain resource associated with the received WUS. The terminal device 110-1 can then start 7040 the DRX on-duration timer of the target DRX configuration. In this way, the terminal device can differentiate the DRX on-duration timer of which DRX configuration to run when the WUS detection windows are overlapped.

Alternatively, WUS of different DRX configuration can be scrambled by different sequences. In this case, several sequences may be preconfigured for scrambling the WUS for different DRX configurations. The terminal device 110-1 may determine a sequence for scrambling the WUS based on blind detection. The terminal device 110-1 may determine a target DRX configuration based on the sequence associated with the received WUS. The terminal device 110-1 can then start 7040 the DRX on-duration timer of the target DRX configuration. In this way, the terminal device can differentiate the DRX on-duration timer of which DRX configuration to run when the WUS detection windows are overlapped.

In some other embodiments, the terminal device 110-1 may start 7040 the DRX on-duration timer based on predetermined information. For example, the terminal device 110-1 may start the DRX on-duration timer with a largest/larger value. As shown in FIG. 8, if the DRX on-duration timer of the DRX configuration #1 is larger than the DRX on-duration timer of the DRX configuration #0, the terminal device 110-1 may start the DRX on-duration timer of the DRX configuration #1. Alternatively, the terminal device 110-1 may start the DRX on-duration timer with a smallest/smaller value. For example, if the DRX on-duration timer of the DRX configuration #1 is larger than the DRX on-duration timer of the DRX configuration #0, the terminal device 110-1 may start the DRX on-duration timer of the DRX configuration #0. In some other embodiments, the terminal device 110-1 may start the DRX on-duration timer which has start time closer/closest to the WUS. For example, as shown in FIG. 8, the start time of the DRX on-duration timer of the DRX configuration #1 is closer to the WUS than the start time of the DRX on-duration timer of the DRX configuration #0. In this case, the terminal device 110-1 may start the DRX on-duration timer of the DRX configuration #1. In this way, the terminal device can differentiate the DRX on-duration timer of which DRX configuration to run when the WUS detection windows are overlapped.

In some embodiments, the network device 120 may transmit 7050 PDCCH for the WUS to the terminal device 110-1. If the PDCCH indicates to start the DRX on-duration timer, the terminal device 110-1 may stop monitoring the PDCCH within the monitoring windows. Alternatively, if the PDCCH indicates not to start the DRX on-duration timer, the terminal device 110-1 may stop monitoring the PDCCH within the monitoring windows and not start any on-duration timer. In this way, the terminal device doesn't need to continue monitoring PDCCH and the power is saved.

In some embodiments, the WUS can be separately configured for each DRX configuration. In this situation, the WUS monitoring occasions of the first DRX configuration may be located in On-duration window of second DRX configuration. For example, the plurality of DRX configurations can comprise a first DRX configuration and a second DRX configuration. A first monitoring window for detecting the WUS of the first DRX configuration can locate within running time of an on-duration timer of the second DRX configuration. For example, as shown in FIG. 9, WUS detection windows of DRX configuration #0 and DRX configuration #1 are 910 and 920 respectively. The WUS detection window 910 is located in the on-duration time window of the DRX configuration #1. The network device may send the WUS in the WUS detection window 910 and/or 920. However, with current WUS detection rule, if the network device sends the group common WUS in the WUS detection window 910 while the drx on-duration timer of DRX configuration #1 is running, the terminal device will not detect the DCI format 2_6 for WUS in WUS detection window 910 because the terminal device is in active time during WUS detection window 910. Then the terminal device will miss the WUS indication for DRX configuration #0, which will degrade the performance of XR flow associated with DRX configuration #0.

In some embodiments, the network device 120 may transmit a PDCCH with group common downlink control information for the WUS within the first WUS monitoring window. For example, the terminal device 110-1 may monitor the PDCCH for group common DCI format of the first DRX configuration in WUS detection window 910. Alternatively, the network device 120 may transmit a PDCCH with specific downlink control information for the WUS within running time of the on-duration timer of the second DRX configuration. In this case, the terminal device 110-1 may not monitor PDCCH for DCI format 2_6 for WUS indication of the first DRX configuration. The WUS indication of the first DRX configuration can be carried in UE specific DCI. The terminal device 110-1 may monitor PDCCH with UE specific DCI for WUS indication of the first DRX configuration in the active time due to the on-duration timer running of the second DRX configuration. The specific DCI format can be scheduling DCI format, e.g., DCI format 0_1/1_1, 0_2/1_2. In some other embodiments, there can be a new field or the unused field in the DCI to indication wake-up information for indicating whether to start the on-duration timer of the first DRX configuration. In some other embodiments, the WUS indication of the second DRX configuration can be carried in UE specific scheduling DCI 930 which schedules the PDSCH 940. When the WUS indicates “1”, the terminal device 110-1 can start the on-duration timer of the first DRX configuration.

Alternatively, the network device 120 may transmit 7060 a MAC CE to the terminal device 110-1. The MAC CE can indicate the WUS indication of the first DRX configuration. For example, the MAC CE carried on the PDSCH 940 may comprise mapping between the WUS and an index of a target DRX configuration.

In some embodiment, if the DRX on-duration windows of the two DRX configurations are overlapped in time domain or the time offset between the DRX on-duration windows smaller than a value x, the terminal device 110-1 may fall back to directly skip the WUS monitoring of the first DRX configuration.

According to above embodiments, if WUS monitoring occasions of the first DRX configuration is located in on-duration window of second DRX configuration, the UE can determine whether start on-duration timer of the first DRX configuration, which improves the system performance.

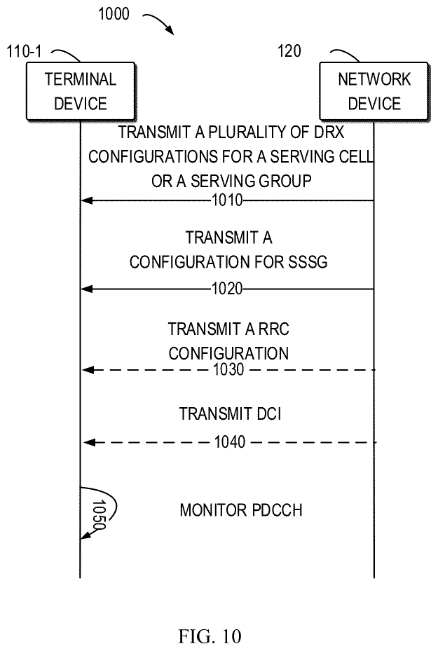

FIG. 10 shows a signaling chart illustrating process 1000 among devices according to some example embodiments of the present disclosure. Only for the purpose of discussion, the process 1000 will be described with reference to FIG. 1. The process 1000 may involve the terminal device 110-1 and the network device 120 in FIG. 1. It should be noted that the process 1000 is only an example not limitation.

The network device 120 transmits 1010 a plurality of DRX configurations for a serving cell or a serving cell group to the terminal device 110-1. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

The network device 120 transmits 1020 a configuration for a search space set group (SSSG) for each DRX configuration. When multiple DRX configurations are configured for different XR flows, each DRX configuration has a corresponding SSSG, the terminal device 110-1 can monitor PDCCH within DRX on-duration time of the DRX configuration based on the SSSG configuration. The terminal device 110-1 can determine the association between DRX configuration index and SSSG index by RRC configuration. The SSSG can be implicitly switched between multiple SSSGs based on the running DRX configuration index for next active duration. For example, if SSSG #0 is configured for DRX configuration #1, SSSG #1 is configured for DRX configuration #0, and when the DRX on-duration timer of the DRX configuration #1 is running, the terminal device will monitor PDCCH according to SSSG #0, after the expiration of DRX on-duration timer of the DRX configuration #1 and the terminal device starts monitoring PDCCH according to SSSG #1, and stops monitoring PDCCH according to SSSG #0, for the serving cell, x ms prior to start of DRX On-duration time of DRX configuration #0. However, when the on-duration time windows of two DRX configurations are overlapped, the overlapped on-duration time window is associated two SSSGs, so it is unclear for the terminal device to monitor PDCCH in the overlapped on-duration time window according to which SSSG.

In some embodiments, the network device 120 may transmit 1030 a RRC configuration to the terminal device 110-1. The RRC configuration may indicate an index of a target SSSG. The terminal device 110-1 may monitor 1050 the PDCCH in the overlapped on-duration time window based on the target SSSG. For example, if the RRC configuration indicates the index of the SSSG 111, the terminal device 110-1 may monitor the PDCCH in the overlapped on-duration time window based on the SSSG 111.

Alternatively, the network device 120 may transmit 1040 DCI to the terminal device 110-1. The DCI may indicate an index of a target SSSG. The terminal device 110-1 may monitor 1050 the PDCCH in the overlapped on-duration time window based on the target SSSG. For example, if the DCI indicate the index of the SSSG 112, the terminal device may monitor the PDCCH based on the SSSG 112. In some other embodiments, the terminal device 110-1 may monitor 1050 the PDCCH based on predetermined information. For example, the SSSG can be preconfigured, and the terminal device 110-1 may always monitor PDCCH in the overlapped on-duration time window according to SSSG #0.

In other embodiments, the overlapped on-duration window can be associated with a first DRX configuration and a second DRX configuration. In this case, the terminal device 110-1 can monitor the PDCCH based on a first SSSG associated with the first DRX configuration and a second SSSG associated with the second DRX configuration within the overlapped on-duration window. For example, the terminal device may monitor the PDCCH according to both SSSG 111 and the SSSG 112.

It should be noted that embodiments described with the reference to FIG. 2, embodiments described with the reference to FIG. 7 and embodiments described with the reference to FIG. 10 can be implemented separately. Alternatively, embodiments described with the reference to FIG. 2, embodiments described with the reference to FIG. 7 and embodiments described with the reference to FIG. 10 can be combined.

FIG. 12 shows a flowchart of an example method 1200 in accordance with an embodiment of the present disclosure. Only for the purpose of illustrations, the method 1200 can be implemented at a terminal device 110-1 as shown in FIG. 1.

At block 1210, the terminal device 110-1 receives a plurality of DRX configurations for a serving cell or a serving cell group from the network device 120. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

At block 1220, the terminal device 110-1 determines a set of target DRX timers or a set of target DRX configurations from the plurality of DRX configurations. The set of target DRX timers can comprise one or more of: the DRX on-duration timer, the DRX inactivity timer, or the DRX retransmission timer.

At block 1230, the terminal device 110-1 monitors a PDCCH based on set of target DRX timers or the set of target DRX configurations. Example embodiments of the determination of the set of target DRX timers and/or the set of target DRX configurations are described with the following figures.

In some embodiments, the plurality of DRX configurations can be running independently. That is to say, the terminal device 110-1 can maintain DRX timers of the plurality of DRX configurations simultaneously. The terminal device 110-1 can monitor the PDCCH according to the set of target DRX timers of the set of DRX configurations separately. In this case, the terminal device 110-1 can monitor the PDCCH when one or more the set of target DRX timers is running. In other words, when multiple DRX configurations are configured, the active time for serving cells in a DRX group includes the time while:—drx-onDurationTimer or drx-InactivityTimer configured of each of the multiple DRX configurations for the DRX group is running; or—drx-RetransmissionTimerDL or drx-RetransmissionTimerUL of each of the multiple DRX configurations is running on any Serving Cell in the DRX group; or—ra-ContentionResolutionTimer or msgB-ResponseWindow\is running; or—a Scheduling Request is sent on PUCCH and is pending; or—a PDCCH indicating a new transmission addressed to the C-RNTI of the MAC entity has not been received after successful reception of a Random Access Response for the Random Access Preamble not selected by the MAC entity among the contention-based Random Access Preamble. In this way, it is easy to implement.

In some embodiments, the on-duration time windows of more than one DRX configuration can be overlapped. In this situation, the terminal device 110-1 may receive the PDCCH scheduling new transmission in such overlapped on-duration time windows. The terminal device 110-1 may start 2040 a target DRX inactivity timer of a DRX configuration from the plurality of DRX configurations. In this case, it is unclear for the terminal device to start the related DRX timer(s) associated which DRX configuration when a PDCCH for scheduling new data transmission is received in the overlapped time window.

The terminal device 110-1 may select the target DRX inactivity timer based on predetermined information. In some embodiments, the terminal device 110-1 may start the target DRX inactivity timer with a smallest/smaller value. Alternatively, the terminal device 110-1 may start the target DRX inactivity with a largest/larger value. In some embodiments, the terminal device 110-1 may start the target DRX inactivity timer with a highest/higher DRX configuration index. Alternatively, the terminal device 110-1 may start the target DRX inactivity timer with a lowest/lower DRX configuration index. In some other embodiments, the terminal device 110-1 may start the target DRX inactivity timer with a shortest/shorter periodicity. Alternatively, the terminal device 110-1 may start the target DRX inactivity timer with a longest/longer periodicity. In some embodiments, the terminal device 110-1 may start the target DRX inactivity timer associated with a XR flow with lowest/lower priority. Alternatively, the terminal device 110-1 may start the target DRX inactivity timer associated with a XR flow with highest/higher priority.

In some embodiment, the network device 120 may transmit a RRC configuration to the terminal device 110-1. In this case, if the RRC configuration indicates an index of the target DRX configuration, the terminal device 110-1 may select the DRX inactivity timer of the target DRX configuration based on the RRC configuration.

Alternatively, the network device 120 may transmit downlink control information (DCI) to the terminal device 110-1. The terminal device 110-1 may select the DRX inactivity timer of the target DRX configuration based on the received DCI. In this case, in some embodiments, the DCI may explicitly indicate the target DRX configuration. For example, the DCI carried in the scheduling PDCCH may comprise a field to indicate the index of the target DRX configuration. In this situation, the terminal device 110-1 may start the DRX inactivity timer of the target DRX configuration. In some other embodiments, the DCI may implicitly indicate the target DRX configuration. For example, the DCI may comprise traffic flow information associated with the target DRX configuration. In this situation, the terminal device 110-1 may start the DRX inactivity timer of associated with the traffic flow.

In some embodiments, the terminal device 110-1 may select the DRX inactivity timer of the target DRX configuration based on the DCI and RRC configuration. For example, the RRC configuration may indicate a table of the plurality of DRX configurations and the DCI may indicate the index of the target DRX configuration. In this case, the terminal deice 110-1 may start the DRX inactivity timer of the target DRX configuration based on the DCI and the RRC configuration. Embodiments of determining the target timer or target DRX configuration can also be applied to DRX retransmission timer determination.

In some embodiments, the terminal device 110-1 may receive a MAC control element (CE) carrying a DRX command from the network device 120 within running time of the plurality of DRX timers of the plurality of DRX configurations. The term “DRX command” used herein can also refer to a long DRX command. In some embodiments, the plurality of DRX timers can be DRX on-duration timers. Alternatively, the plurality of DRX timers can be DRX inactivity timers. Alternatively, the plurality of DRX timers can be DRX inactivity timers and DRX on-duration timers. In some embodiments, the MAC CE can indicate the index of the target DRX configuration. For example, the MAC CE may comprise a field for indicating the index of the target DRX configuration. In this case, the terminal device 110-1 can apply the DRX command for the target DRX configuration. The terminal device 110-1 can stop the DRX on-duration timer and/or the DRX inactivity timer of the target DRX configuration.

Alternatively, the terminal device 110-1 can apply the DRX command for the plurality of DRX configurations. The terminal device 110-1 can stop all of the DRX on-duration timer and/or the DRX inactivity timer of the plurality of DRX configurations.

In some other embodiments, the network device 120 may transmit, to the terminal device 110-1, DCI which schedules a PDSCH transmission for a traffic flow. In this case, if the terminal device 110-1 receives the MAC CE associated with the PDSCH carrying the DRX command within running time of the plurality of DRX timers of the plurality of DRX configurations, the terminal device 110-1 may cause the DRX on-duration timer and/or the DRX inactivity timer of the target DRX configuration associated with the traffic flow to be stopped.

In some other embodiments, the plurality of DRX configurations can be running jointly. For example, the plurality of DRX configurations can comprise a first DRX configuration which comprises a first DRX timer on-duration and a second DRX configuration which comprises a second on-duration DRX timer. In this case, the terminal device 110-1 can monitor the PDCCH during running time of the first DRX on-duration timer. If a time offset between an ending symbol of the first DRX timer and a start symbol of the second DRX timer does not exceed a predetermined or configured gap, the terminal device 110-1 will skip the second DRX timer. In other words, the terminal device 110-1 will not start the second DRX timer. In other words, when multiple DRX configurations are configured, if drx-onDurationTimer of the first DRX configuration is running and time gap between the ending time of drx-onDurationTimer of the first DRX configuration and the start time of drx-onDurationTimer of the second DRX configuration is smaller than the Gap value m, the terminal device will not start the drx-onDurationTimer of the second DRX configuration in this DRX cycle. The Active Time for Serving Cells in a DRX group includes the time while:—drx-onDurationTimer or drx-InactivityTimer configured for the DRX group is running; or—drx-RetransmissionTimerDL or drx-RetransmissionTimerUL is running on any Serving Cell in the DRX group; or—ra-ContentionResolutionTimer or msgB-ResponseWindow is running; or—a Scheduling Request is sent on PUCCH and is pending; or—a PDCCH indicating a new transmission addressed to the C-RNTI of the MAC entity has not been received after successful reception of a Random Access Response for the Random Access Preamble not selected by the MAC entity among the contention-based Random Access Preamble. In this way, it provides more sleep time for the terminal device and there are no overlapped on-duration time windows generated.

In some other embodiments, the plurality of DRX configurations can be running jointly. For example, the plurality of DRX configurations can comprise a first DRX configuration which comprises a first DRX on-duration timer and a second DRX configuration which comprises a second DRX on-duration timer. If start time of the second DRX on-duration timer is located in the running time of the first DRX on-duration timer, the terminal device 110-1 may monitor PDCCH based on a third DRX on-duration timer, which is generated based on the first DRX on-duration timer and the second DRX on-duration timer. The start time of the third DRX on-duration timer is same with the first DRX on-duration timer which has an earlier start point. The ending time of the third DRX on-duration timer is same with the DRX on-duration timer among the first and second DRX on-duration timer which has the latest ending point.

In some embodiments, one of the plurality of DRX configurations can be running. In other words, the terminal device 110-1 can maintain timers of one DRX configuration. The terminal device 110-1 can switch the active DRX configuration among the plurality of DRX configurations. For example, the plurality of DRX configurations can comprise a first DRX configuration which comprises a first set of DRX timers and a second DRX configuration which comprises a second set of DRX timers. In this case, the terminal device 110-1 can monitor the PDCCH during running time of the first set of DRX timers. In some embodiments, if the terminal device 110-1 receives DCI comprising a switch indication from the network device 120, the terminal device 110-1 may switch to the second set of DRX timers. Alternatively, if a switch timer at the terminal device 110-1 expires, the terminal device 110-1 may switch to the second set of DRX timers. In this case, the terminal device 110-1 then can monitor the PDCCH during running time of the second set of DRX timers. In this way, it provides more sleep time for the terminal device and there is no overlapped on-durations. As mentioned above, the terminal device 110-1 may switch to the second set of DRX timers based on a switch timer. In this case, the switch timer can be configured via RRC configuration. The value of the switch timer can be based on the periodicity of traffic flows.

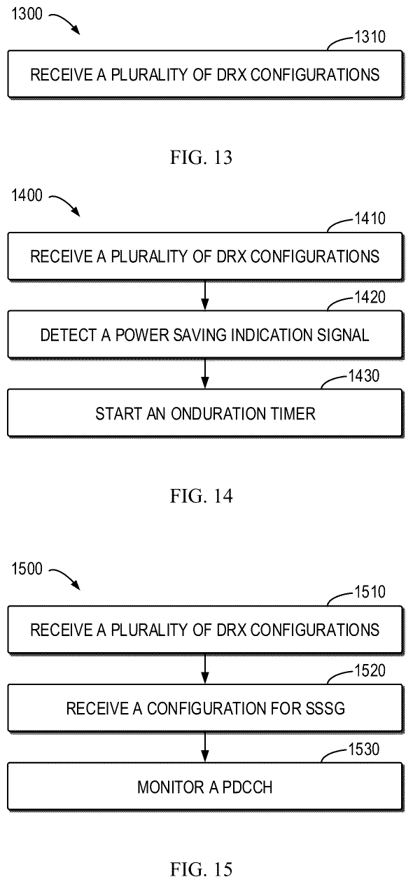

FIG. 13 shows a flowchart of an example method 1300 in accordance with an embodiment of the present disclosure. Only for the purpose of illustrations, the method 1300 can be implemented at a network device 120 as shown in FIG. 1.

At block 1310, the network device 120 transmits a plurality of DRX configurations for a serving cell or a serving cell group to the terminal device 110-1. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

FIG. 14 shows a flowchart of an example method 1400 in accordance with an embodiment of the present disclosure. Only for the purpose of illustrations, the method 1400 can be implemented at a terminal device 110-1 as shown in FIG. 1.

At block 1410, the terminal device 110-1 receives a plurality of DRX configurations for a serving cell or a serving cell group from the network device 120. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

At block 1420, the terminal device 110-1 detects a power saving indication signal within a monitoring window. The monitoring window is associated within one or more DRX configurations of the plurality of DRX configurations. In some embodiments, the power saving indication signal can be a wake up signal (WUS). Alternatively, the power saving indication signal can be a low power WUS. In some other embodiments, the power saving indication signal can be a PDDCH skipping indication which is included in DCI. The DCI which comprises the PDDCH skipping indication can indicate that the terminal device can skip monitoring the PDCCH for certain duration. The DCI also indicates the length of the certain duration in time domain. Such duration can comprise a set of symbols, a set of slots or a set of DRX cycles. It should be noted that the power saving indication signal can also be any proper signals. Only for the purpose of illustrations, the power saving indication signal can refer to wake up signal (WUS) hereinafter.

A wake-up signal (WUS) indication conveyed by DCI signaling with a DCI format 2_6, which is scrambled by a power saving radio network temporary identifier (PS-RNTI), can be used to inform the terminal device whether or not to start the DRX on-duration timer for the next DRX cycle for potential data scheduling. A WUS detection window (search space set) can be configured before the on-duration of a DRX configuration for PDCCH monitoring for WUS, and one or more PDCCH occasions in the WUS window should be detected. The terminal device can detect the WUS DCI before DRX On-duration. If the wake-up indication sets to “1”, the terminal device should start the DRX on-duration timer. Otherwise, the terminal device does not need to start the timer.

Alternatively, different frequency domain resources (for example, control resource set (CORESET)) can be configured for WUS monitoring occasion of different DRX configurations. In this case, the terminal device 110-1 may determine a frequency domain resource of the monitoring window. The terminal device 110-1 may determine a target DRX configuration based on the frequency domain resource associated with the received WUS. The terminal device 110-1 can then start 7040 the DRX on-duration timer of the target DRX configuration. In this way, the terminal device can differentiate the DRX on-duration timer of which DRX configuration to run when the WUS detection windows are overlapped.

Alternatively, WUS of different DRX configuration can be scrambled by different sequences. In this case, several sequences may be preconfigured for scrambling the WUS for different DRX configurations. The terminal device 110-1 may determine a sequence for scrambling the WUS based on blind detection. The terminal device 110-1 may determine a target DRX configuration based on the sequence associated with the received WUS. The terminal device 110-1 can then start the DRX on-duration timer of the target DRX configuration. In this way, the terminal device can differentiate the DRX on-duration timer of which DRX configuration to run when the WUS detection windows are overlapped.

At block 1430, the terminal device 110-1 may start the DRX on-duration timer. In some other embodiments, the terminal device 110-1 may start the DRX on-duration timer based on predetermined information. For example, the terminal device 110-1 may start the DRX on-duration timer with a largest/larger value. Alternatively, the terminal device 110-1 may start the DRX on-duration timer with a smallest/smaller value. In some other embodiments, the terminal device 110-1 may start the DRX on-duration timer which has start time closer/closest to the WUS.

In some embodiments, the network device 120 may transmit PDCCH for the WUS to the terminal device 110-1. If the PDCCH indicates to start the DRX on-duration timer, the terminal device 110-1 may stop monitoring the PDCCH within the monitoring windows. Alternatively, if the PDCCH indicates not to start the DRX on-duration timer, the terminal device 110-1 may stop monitoring the PDCCH within the monitoring windows and not start any on-duration timer. In this way, the terminal device doesn't need to continue monitoring PDCCH and the power is saved.

In some embodiments, the WUS can be separately configured for each DRX configuration. In this situation, the WUS monitoring occasions of the first DRX configuration may be located in On-duration window of second DRX configuration. For example, the plurality of DRX configurations can comprise a first DRX configuration and a second DRX configuration. A first monitoring window for detecting the WUS of the first DRX configuration can locate within running time of an on-duration timer of the second DRX configuration.

In some embodiments, the network device 120 may transmit a PDCCH with group common downlink control information for the WUS within the first WUS monitoring window. For example, the terminal device 110-1 may monitor the PDCCH for group common DCI format of the first DRX configuration. Alternatively, the network device 120 may transmit a PDCCH with specific downlink control information for the WUS within running time of the on-duration timer of the second DRX configuration. In this case, the terminal device 110-1 may not monitor PDCCH for DCI format 2_6 for WUS indication of the first DRX configuration. The WUS indication of the first DRX configuration can be carried in UE specific DCI. The terminal device 110-1 may monitor PDCCH with UE specific DCI for WUS indication of the first DRX configuration in the active time due to the on-duration timer running of the second DRX configuration. The specific DCI format can be scheduling DCI format, e.g., DCI format 0_1/1_1, 0_2/1_2. In some other embodiments, there can be a new field or the unused field in the DCI to indication wake-up information for indicating whether to start the on-duration timer of the first DRX configuration.

Alternatively, the network device 120 may transmit a MAC CE to the terminal device 110-1. The MAC CE can indicate the WUS indication of the first DRX configuration. For example, the MAC CE carried on the PDSCH may comprise mapping between the WUS and an index of a target DRX configuration.

In some embodiment, if the DRX on-duration windows of the two DRX configurations are overlapped in time domain or the time offset between the DRX on-duration windows smaller than a value x, the terminal device 110-1 may fall back to directly skip the WUS monitoring of the first DRX configuration.

According to above embodiments, if WUS monitoring occasions of the first DRX configuration is located in on-duration window of second DRX configuration, the UE can determine whether start on-duration timer of the first DRX configuration, which improves the system performance.

FIG. 15 shows a flowchart of an example method 1500 in accordance with an embodiment of the present disclosure. Only for the purpose of illustrations, the method 1500 can be implemented at a terminal device 110-1 as shown in FIG. 1.

At block 1510, the terminal device 110-1 receives a plurality of DRX configurations for a serving cell or a serving cell group from the network device 120. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

At block 1520, the terminal device 110-1 receives a configuration for a search space set group (SSSG) for each DRX configuration. When multiple DRX configurations are configured for different XR flows, each DRX configuration has a corresponding SSSG, the terminal device 110-1 can monitor PDCCH within DRX on-duration time of the DRX configuration based on the SSSG configuration. The terminal device 110-1 can determine the association between DRX configuration index and SSSG index by RRC configuration. The SSSG can be implicitly switched between multiple SSSGs based on the running DRX configuration index for next active duration. For example, if SSSG #0 is configured for DRX configuration #1, SSSG #1 is configured for DRX configuration #0, and when the DRX on-duration timer of the DRX configuration #1 is running, the terminal device will monitor PDCCH according to SSSG #0, after the expiration of DRX on-duration timer of the DRX configuration #1 and the terminal device starts monitoring PDCCH according to SSSG #1, and stops monitoring PDCCH according to SSSG #0, for the serving cell, x ms prior to start of DRX On-duration time of DRX configuration #0. However, when the on-duration time windows of two DRX configurations are overlapped, the overlapped on-duration time window is associated two SSSGs, so it is unclear for the terminal device to monitor PDCCH in the overlapped on-duration time window according to which SSSG.

At block 1530, the terminal device 110-1 may monitor the PDCCH based on the target SSSG. In some embodiments, the network device 120 may transmit a RRC configuration to the terminal device 110-1. The RRC configuration may indicate an index of a target SSSG. The terminal device 110-1 may monitor 1050 the PDCCH in the overlapped on-duration time window based on the target SSSG.

Alternatively, the network device 120 may transmit DCI to the terminal device 110-1. The DCI may indicate an index of a target SSSG. The terminal device 110-1 may monitor the PDCCH in the overlapped on-duration time window based on the target SSSG. For example, the SSSG can be preconfigured.

In other embodiments, the overlapped on-duration window can be associated with a first DRX configuration and a second DRX configuration. In this case, the terminal device 110-1 can monitor the PDCCH based on a first SSSG associated with the first DRX configuration and a second SSSG associated with the second DRX configuration within the overlapped on-duration window.

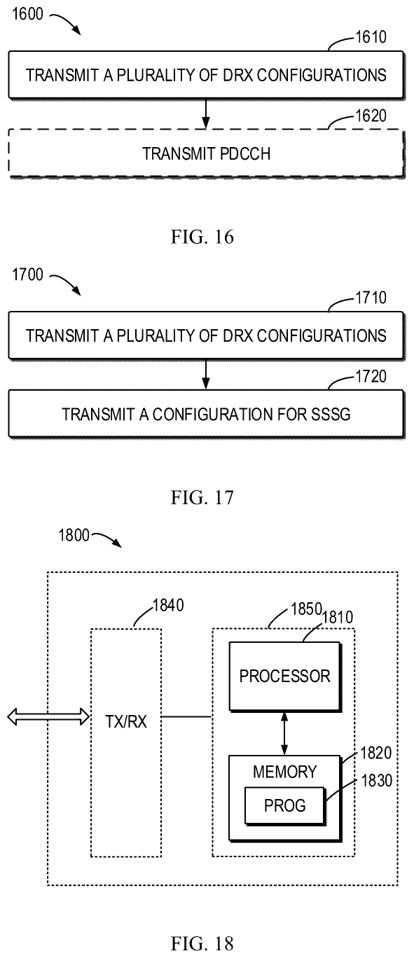

FIG. 16 shows a flowchart of an example method 1600 in accordance with an embodiment of the present disclosure. Only for the purpose of illustrations, the method 1600 can be implemented at a network device 120 as shown in FIG. 1.

At block 1610, the network device 120 transmits a plurality of DRX configurations for a serving cell or a serving cell group to the terminal device 110-1. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

In some embodiments, at block 1620, the network device 120 may transmit PDCCH for the WUS to the terminal device 110-1. If the PDCCH indicates to start the DRX on-duration timer, the terminal device 110-1 may stop monitoring the PDCCH within the monitoring windows. Alternatively, if the PDCCH indicates not to start the DRX on-duration timer, the terminal device 110-1 may stop monitoring the PDCCH within the monitoring windows and not start any on-duration timer. In this way, the terminal device can differentiate the DRX on-duration timer of which DRX configuration to run when the WUS detection windows are overlapped.

In some embodiments, the WUS can be separately configured for each DRX configuration. In this situation, the WUS monitoring occasions of the first DRX configuration may be located in on-duration window of second DRX configuration. For example, the plurality of DRX configurations can comprise a first DRX configuration and a second DRX configuration. A first monitoring window for detecting the WUS of the first DRX configuration can locate within running time of an on-duration timer of the second DRX configuration.

In some embodiments, the network device 120 may transmit a PDCCH with group common downlink control information for the WUS within the first WUS monitoring window. For example, the terminal device 110-1 may monitor the PDCCH for group common DCI format of the first DRX configuration in WUS detection window. Alternatively, the network device 120 may transmit a PDCCH with specific downlink control information for the WUS within running time of the on-duration timer of the second DRX configuration. In this case, the terminal device 110-1 may not monitor PDCCH for DCI format 2_6 for WUS indication of the first DRX configuration. The WUS indication of the first DRX configuration can be carried in UE specific DCI. The terminal device 110-1 may monitor PDCCH with UE specific DCI for WUS indication of the first DRX configuration in the active time due to the on-duration timer running of the second DRX configuration. The specific DCI format can be scheduling DCI format, e.g., DCI format 0_1/1_1, 0_2/1_2. In some other embodiments, there can be a new field or the unused field in the DCI to indication wake-up information for indicating whether to start the on-duration timer of the first DRX configuration.

Alternatively, the network device 120 may transmit a MAC CE to the terminal device 110-1. The MAC CE can indicate the WUS indication of the first DRX configuration. For example, the MAC CE carried on the PDSCH may comprise mapping between the WUS and an index of a target DRX configuration.

In some embodiment, if the DRX on-duration windows of the two DRX configurations are overlapped in time domain or the time offset between the DRX on-duration windows smaller than a value x, the terminal device 110-1 may fall back to directly skip the WUS monitoring of the first DRX configuration.

According to above embodiments, if WUS monitoring occasions of the first DRX configuration is located in On-duration window of second DRX configuration, the UE can determine whether start On-duration timer of the first DRX configuration, which improves the system performance.

FIG. 17 shows a flowchart of an example method 1700 in accordance with an embodiment of the present disclosure. Only for the purpose of illustrations, the method 1700 can be implemented at a network device 120 as shown in FIG. 1.

At block 1710, the terminal device 110-1 receives a plurality of DRX configurations for a serving cell or a serving cell group from the network device 120. The DRX configuration may comprise one or more of the following parameters: (1) a DRX on-duration timer: the duration at the beginning of a DRX cycle; (2) a DRX slot offset: the delay before starting the DRX on-duration timer; (3) a DRX inactivity timer: the duration after the physical downlink control channel (PDCCH) occasion in which a PDCCH indicates a new uplink (UL) or downlink (DL) transmission for a medium access control (MAC) entity; (4) a DRX retransmission timer DL (per DL hybrid automatic repeat request (HARQ) process except for the broadcast process): the maximum duration until a DL retransmission is received; (5) a DRX retransmission timer UL (per UL HARQ process): the maximum duration until a grant for UL retransmission is received; (6) a DRX long cycle start offset: the long DRX cycle and DRX start offset which defines the subframe where the long and short DRX cycle starts; (7) a DRX short cycle: the short DRX cycle; (8) a DRX short cycle timer: the duration the UE shall follow the short DRX cycle; (9) a DRA HARQ round trip time (RTT) timer DL (per DL HARQ process except for the broadcast process): the minimum duration before a DL assignment for HARQ retransmission is expected by the MAC entity; (10) a DRX HARQ RTT timer UL (per UL HARQ process): the minimum duration before a UL HARQ retransmission grant is expected by the MAC entity; (11) a PS wake up: the configuration to start an associated DRX on-duration timer in case DCP is monitored but not detected; (12) a PS transmit other periodic CSI: the configuration to report periodic channel state information (CSI) that is not layer 1 reference signal received power (L1-RSRP) on physical uplink control channel (PUCCH) during the time duration indicated by the DRX on-duration timer in case DCP is configured but the associated DRX on-duration timer is not started; (13) a PS transmit periodic L1-RSRP: the configuration to transmit periodic CSI that is L1-RSRP on PUCCH during the time duration indicated by the DRX on-duration timer in case DCP is configured but the associated the DRX on-duration timer is not started.

In some embodiments, each of the multiple DRX configurations can be separately configured. For example, the above mentioned parameters can be separately configured for each DRX configuration. Alternatively, each of the plurality of DRX configurations may comprise a set of RRC parameters which is common to the plurality of DRX configurations and another set of RRC parameters which is dedicated to the DRX configuration. In other words, some of the above mentioned parameters can be separately configured for each configuration and other parameters can be common for the plurality of DRX configurations in the serving cell or the serving cell group. For example, one or more of the following parameters can be separately configured for different DRX configurations: the DRX slot offset, the DRX long cycle start offset, the DRX short cycle. In this way, it achieves configuration for multiple DRX configurations for one serving cell or serving cell group.

At block 1720, the network device 120 transmits a configuration for a search space set group (SSSG) for each DRX configuration to the terminal device 110-1. When multiple DRX configurations are configured for different XR flows, each DRX configuration has a corresponding SSSG, the terminal device 110-1 can monitor PDCCH within DRX on-duration time of the DRX configuration based on the SSSG configuration. The terminal device 110-1 can determine the association between DRX configuration index and SSSG index by RRC configuration. The SSSG can be implicitly switched between multiple SSSGs based on the running DRX configuration index for next active duration. For example, if SSSG #0 is configured for DRX configuration #1, SSSG #1 is configured for DRX configuration #0, and when the DRX on-duration timer of the DRX configuration #1 is running, the terminal device will monitor PDCCH according to SSSG #0, after the expiration of DRX on-duration timer of the DRX configuration #1 and the terminal device starts monitoring PDCCH according to SSSG #1, and stops monitoring PDCCH according to SSSG #0, for the serving cell, x ms prior to start of DRX On-duration time of DRX configuration #0. However, when the on-duration time windows of two DRX configurations are overlapped, the overlapped on-duration time window is associated two SSSGs, so it is unclear for the terminal device to monitor PDCCH in the overlapped on-duration time window according to which SSSG.

In some embodiments, the network device 120 may transmit a RRC configuration to the terminal device 110-1. The RRC configuration may indicate an index of a target SSSG. Alternatively, the network device 120 may transmit DCI to the terminal device 110-1. The DCI may indicate an index of a target SSSG. In other embodiments, the overlapped on-duration window can be associated with a first DRX configuration and a second DRX configuration.

In some embodiments, a terminal device comprises circuitry configured to: receive, from a network device, a plurality of discontinuous reception (DRX) configurations for a serving cell or a serving cell group; determine, at the terminal device, a set of target DRX timers or a set of target DRX configurations of the plurality of DRX configurations; and monitor, at the terminal device, a physical downlink control channel (PDCCH) based on the set of target DRX timers or the set of target DRX configurations.

In some embodiments, the terminal device comprises circuitry configured to maintain a plurality of DRX timers of the plurality of DRX configurations; and the terminal device comprises circuitry configured to monitor the PDCCH by monitoring the PDCCH during running time of one or more DRX timers of the set of target DRX timers.

In some embodiments, the one or more DRX timers comprise at least one of: a DRX on-duration timer, a DRX inactivity timer, or a DRX retransmission timer.

In some embodiments, the terminal device comprises circuitry configured to receive the PDCCH on the serving cell within an on-duration time window based on a plurality of DRX on-duration timers associated with the plurality of DRX configurations; and the terminal device comprises circuitry configured to determine the set of target DRX timers by: determining a target DRX inactivity timer of a DRX configuration from the plurality of DRX configurations; and starting the target DRX inactivity timer.

In some embodiments, the terminal device comprises circuitry configured to determine the target DRX inactivity timer by selecting the target DRX inactivity timer based on predetermined information, wherein the predetermined information indicates one of: the target DRX inactivity timer with a smallest or largest value among the plurality of DRX inactive timers, the target DRX inactivity timer of the DRX configuration with a highest or lowest configuration index among the plurality of DRX configurations, the target DRX inactivity timer of the DRX configuration with a longest or shortest DRX periodicity among the plurality of DRX configurations; or the target DRX inactivity timer of the DRX configuration associated with a traffic flow with a highest or lowest priority value among a plurality of traffic flows.

In some embodiments, the terminal device comprises circuitry configured to determine the target DRX inactivity timer by determining the target DRX inactivity timer based on at least one of: a radio resource control (RRC) configuration or downlink control information.

In some embodiments, the RRC configuration indicates an index of the target DRX configuration, or the downlink control information indicates one of: an index of the target DRX configuration or a traffic flow associated with the DRX configuration; the RRC configuration indicates a table of the plurality of DRX configurations and the downlink control information indicates an index of the target DRX configuration.

In some embodiments, the terminal device comprises circuitry configured to receive a medium access control control element (MAC CE) carrying a DRX command within running time of the plurality of DRX timers of the plurality of DRX configuration, wherein the MAC CE indicates an index of a target DRX configuration and each of the plurality of DRX timers comprises a DRX on-duration timers or a DRX inactivity timer; apply the DRX command for the target DRX configuration; and cause a DRX on-duration timer or a DRX inactivity timer of the target DRX configuration to be stopped.

In some embodiments, the terminal device comprises circuitry configured to receive a medium access control control element (MAC CE) carrying a DRX command within running time of the plurality of DRX timers of the plurality of DRX configuration, wherein each of the plurality of DRX timers comprises a DRX on-duration timers or a DRX inactivity timer; and cause the plurality of DRX timers to be stopped.

In some embodiments, the terminal device comprises circuitry configured to receive downlink control information, wherein the downlink control information schedules a physical downlink shared channel (PDSCH) transmission for a third traffic flow; receive a MAC CE carrying a DRX command within running time of the plurality of DRX timers of the plurality of DRX configuration; wherein each of the plurality of DRX timers comprises a DRX on-duration timers or a DRX inactivity timer; and cause a DRX on-duration timer or a DRX inactivity timer of a target DRX configuration associated with the third traffic flow to be stopped.

In some embodiments, the plurality of DRX configurations comprises a first DRX configuration and a second DRX configuration, the first DRX configuration comprises a first DRX timer and the second configuration comprises a second DRX timer, and wherein the terminal device comprises circuitry configured to monitor the PDCCH based on the at least one DRX configuration by: monitoring the PDCCH during running time of the first DRX timer; and in accordance with a determination that a time offset between an ending symbol of the first DRX timer and a start symbol of the second DRX timer does not exceed a predetermined or configured gap, causing the second DRX timer to be skipped.

In some embodiments, the plurality of DRX configurations comprises a first DRX configuration and a second DRX configuration, the first DRX configuration comprises a first set of DRX timers and the second configuration comprises a second set of DRX timers, and the terminal device comprises circuitry configured to monitor the PDCCH based on the at least one DRX configuration by: monitoring the PDCCH during running time of the first set of DRX timers; in accordance with a determination that downlink control information received from the network device comprises a switch indication, switching to the second set of DRX timers; and monitoring the PDCCH during running time of the second set of DRX timers.

In some embodiments, the plurality of DRX configurations comprises a first DRX configuration and a second DRX configuration, the first DRX configuration comprises a first set of DRX timers and the second configuration comprises a second set of DRX timers, and the terminal device comprises circuitry configured to monitor the PDCCH based on the at least one DRX configuration by: monitoring the PDCCH during running time of the first set of DRX timers; in accordance with a determination that a switch timer expires, switching to the second set of DRX timers; and monitoring the PDCCH during running time of the second set of DRX timers.

In some embodiments, each of the plurality of DRX configurations comprises a set of dedicated RRC parameters.

In some embodiments, each of the plurality of DRX configurations comprises a first set of common RRC parameters, and a second set of dedicated RRC parameters.

In some embodiments, a terminal device comprises circuitry configured to: receive, from a network device, a plurality of discontinuous reception (DRX) configurations for a serving cell or a serving cell group; detect, at the terminal device, a power saving indication signal within a monitoring window, wherein the monitoring window is associated with one or more DRX configurations of the plurality of DRX configurations; and start a DRX on-duration timer of one of the plurality of DRX configurations based on the detection of the power saving indication signal.

In some embodiments, the terminal device comprises circuitry configured to: determine a frequency domain resource of the monitoring window; and determine a target DRX configuration from the plurality of DRX configurations based on the frequency domain resource; and wherein the terminal device comprises circuitry configured to start the DRX on-duration timer by starting the DRX on-duration timer of the target DRX configuration.

In some embodiments, the terminal device comprises circuitry configured to: determine a sequence for scrambling the power saving indication signal; determine a target DRX configuration from the plurality of DRX configurations based on the sequence; and wherein the terminal device comprises circuitry configured to start the DRX on-duration timer by starting the DRX on-duration timer of the target DRX configuration.

In some embodiments, the DRX on-duration timer is one of: the DRX on-duration timer with a largest value, the DRX on-duration timer with a smallest value, or the DRX on-duration timer which has start time closest to the WUS.

In some embodiments, the terminal device comprises circuitry configured to: receive, from the network device, a radio resource control (RRC) configuration which indicates a target DRX configuration; and wherein the terminal device comprises circuitry configured to start the DRX on-duration timer by starting the DRX on-duration timer of the target DRX configuration.

In some embodiments, the terminal device comprises circuitry configured to: in accordance with a determination that downlink control information for the power saving indication signal indicates to start the DRX on-duration timer, stop monitoring the PDCCH within the monitoring window.

In some embodiments, the terminal device comprises circuitry configured to: in accordance with a determination that a PDCCH for the power saving indication signal indicates not to start the DRX on-duration timer, stop monitoring the PDCCH within the monitoring window; and cause the DRX on-duration timers of the plurality of DRX configurations to be skipped.

In some embodiments, the plurality of DRX configurations comprises a first DRX configuration and a second DRX configuration, and a first monitoring window of the first DRX configuration for detecting the power saving indication signal is located within running time of an on-duration timer of the second DRX configuration.

In some embodiments, the terminal device comprises circuitry configured to: receive a PDCCH with group common downlink control information for the power saving indication signal within the first monitoring window.

In some embodiments, the terminal device comprises circuitry configured to: receive a PDCCH with specific downlink control information for the power saving indication signal within the running time of the on-duration timer of the second DRX configuration.

In some embodiments, the terminal device comprises circuitry configured to: receive, from the network device, a medium access control control element (MAC CE) indicating mapping between the power saving indication signal and an index of a target DRX configuration.

In some embodiments, a terminal device comprises circuitry configured to: receive, from a network device, a plurality of discontinuous reception (DRX) configurations for a serving cell or a serving cell group; receive, at the terminal device and from the network device, a configuration for a search space set group (SSSG) for each DRX configuration; and monitor, at the terminal device, a physical downlink control channel (PDCCH) based on one or more search space set group (SSSG) within an overlapped on-duration window of the plurality of DRX configurations.

In some embodiments, the terminal device comprises circuitry configured to: monitor the PDCCH by monitoring the PDCCH based on a predetermined SSSG.

In some embodiments, the terminal device comprises circuitry configured to: receive, from the network device, a radio resource control configuration indicating an index of a target SSSG; and wherein the terminal device comprises circuitry configured to monitor the PDCCH by monitoring the PDCCH based on the target SSSG.

In some embodiments, the terminal device comprises circuitry configured to: receive, from the network device, downlink control information indicating an index of a target SSSG; and wherein the terminal device comprises circuitry configured to monitor the PDCCH by monitoring the PDCCH based on the target SSSG.

In some embodiments, the overlapped on-duration window is associated with a first DRX configuration and a second DRX configuration; and wherein the terminal device comprises circuitry configured to monitor the PDCCH by monitoring the PDCCH based on a first SSSG associated with the first DRX configuration and a second SSSG associated with the second DRX configuration within the overlapped on-duration window.

In some embodiments, a network device comprises circuitry configured to: transmit, to a terminal device, a plurality of discontinuous reception (DRX) configurations for a serving cell or a serving cell group; and transmit, at the network device and to the terminal device, a configuration for a search space set group (SSSG) for each DRX configuration.

In some embodiments, the network device comprises circuitry configured to: transmit, to the terminal device, a radio resource control configuration indicating an index of a target SSSG.

In some embodiments, the network device comprises circuitry configured to: transmit, to the terminal device downlink control information indicating an index of a target SSSG.

FIG. 18 is a simplified block diagram of a device 1800 that is suitable for implementing embodiments of the present disclosure. The device 1800 can be considered as a further example implementation of the network device 120, or the terminal device 110 as shown in FIG. 1. Accordingly, the device 1800 can be implemented at or as at least a part of the terminal device 110, or the network device 120.

As shown, the device 1800 includes a processor 1810, a memory 1820 coupled to the processor 1810, a suitable transmitter (TX) and receiver (RX) 1840 coupled to the processor 1810, and a communication interface coupled to the TX/RX 1840. The memory 1810 stores at least a part of a program 1830. The TX/RX 1840 is for bidirectional communications. The TX/RX 1840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

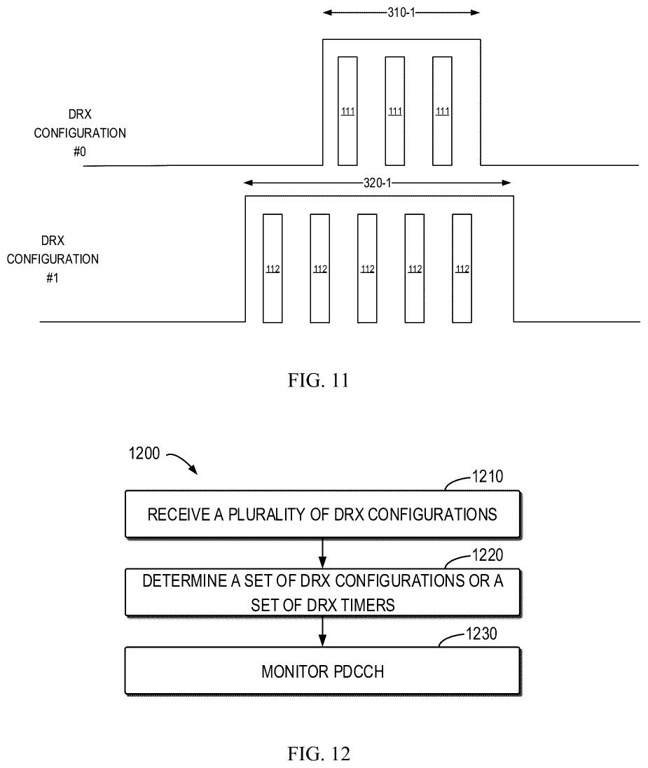

The program 1830 is assumed to include program instructions that, when executed by the associated processor 1810, enable the device 1800 to operate in accordance with the embodiments of the present disclosure, as discussed herein with reference to FIGS. 2 to 17. The embodiments herein may be implemented by computer software executable by the processor 1810 of the device 1800, or by hardware, or by a combination of software and hardware. The processor 1810 may be configured to implement various embodiments of the present disclosure. Furthermore, a combination of the processor 1810 and memory 1820 may form processing means adapted to implement various embodiments of the present disclosure.

The memory 1820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1820 is shown in the device 1800, there may be several physically distinct memory modules in the device 1800. The processor 1810 may be of any type suitable to the local technical network, and may include one or more of general purpose computers, special purpose computers, microprocessors, digital signal processors (DSPs) and processors based on multicore processor architecture, as non-limiting examples. The device 1800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz(THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1. A communication method, comprising:
receiving, at a terminal device and from a network device, a plurality of discontinuous reception (DRX) configurations for a serving cell or a serving cell group;
detecting, at the terminal device, a power saving indication signal within a monitoring window, wherein the monitoring window is associated with one or more DRX configurations of the plurality of DRX configurations; and
starting a DRX on-duration timer of one of the plurality of DRX configurations based on the detection of the power saving indication signal.

2. The method of claim 1, further comprising:
determining a frequency domain resource of the monitoring window; and
determining a target DRX configuration from the plurality of DRX configurations based on the frequency domain resource associated with the power saving indication signal; and
wherein starting the DRX on-duration timer comprises:
starting the DRX on-duration timer of the target DRX configuration.

3. The method of claim 1, further comprising:
determining a sequence for scrambling the power saving indication signal;
determining a target DRX configuration from the plurality of DRX configurations based on the sequence; and
wherein starting the DRX on-duration timer comprises:
starting the DRX on-duration timer of the target DRX configuration.

4. The method of claim 1, wherein the DRX on-duration timer is one of:
the DRX on-duration timer with a largest value,
the DRX on-duration timer with a smallest value, or
the DRX on-duration timer which has start time closest to the WUS.

5. The method of claim 1, further comprising:
receiving, from the network device, a radio resource control (RRC) configuration which indicates a target DRX configuration; and
wherein starting the DRX on-duration timer comprises:
starting the DRX on-duration timer of the target DRX configuration.

6. The method of claim 1, further comprising:
in accordance with a determination that downlink control information for the power saving indication signal indicates to start the DRX on-duration timer, stopping monitoring the PDCCH within the monitoring window.

7. The method of claim 1, further comprising:
in accordance with a determination that a PDCCH for the power saving indication signal indicates not to start the DRX on-duration timer, stopping monitoring the PDCCH within the monitoring window; and
causing the DRX on-duration timers of the plurality of DRX configurations to be skipped.

8. The method of claim 1, wherein the plurality of DRX configurations comprises a first DRX configuration and a second DRX configuration, and a first monitoring window of the first DRX configuration for detecting the power saving indication signal is located within running time of an on-duration timer of the second DRX configuration.

9. The method of claim 8, further comprising:
receiving a PDCCH with group common downlink control information for the power saving indication signal within the first monitoring window.

10. The method of claim 8, further comprising:
receiving a PDCCH with specific downlink control information for the power saving indication signal within the running time of the on-duration timer of the second DRX configuration.

11. The method of claim 8, further comprising:
receiving, from the network device, a medium access control control element (MAC CE) indicating mapping between the power saving indication signal and an index of a target DRX configuration.

12. A communication method, comprising:
receiving, at a terminal device and from a network device, a plurality of discontinuous reception (DRX) configurations for a serving cell or a serving cell group;
receiving, at the terminal device and from the network device, a configuration of a search space set group (SSSG) for each DRX configuration; and
monitoring, at the terminal device, a physical downlink control channel (PDCCH) based on one or more search space set group (SSSG) within an overlapped on-duration window of the plurality of DRX configurations.

13. The method of claim 12, wherein monitoring the PDCCH comprises:
monitoring the PDCCH based on a predetermined SSSG.

14. The method of claim 12, further comprising:
receiving, from the network device, a radio resource control configuration indicating an index of a target SSSG; and
wherein monitoring the PDCCH comprises:
monitoring the PDCCH based on the target SSSG.

15. The method of claim 12, further comprising:
receiving, from the network device, downlink control information indicating an index of a target SSSG; and
wherein monitoring the PDCCH comprises:
monitoring the PDCCH based on the target SSSG.

16. The method of claim 12, wherein the overlapped on-duration window is associated with a first DRX configuration and a second DRX configuration; and
wherein monitoring the PDCCH comprises:
monitoring the PDCCH based on a first SSSG associated with the first DRX configuration and a second SSSG associated with the second DRX configuration within the overlapped on-duration window.

17. A communication method, comprising:
transmitting, at a network device and to a terminal device, a plurality of discontinuous reception (DRX) configurations for a serving cell or a serving cell group; and
transmitting, at the network device and to the terminal device, a configuration of a search space set group (SSSG) for each DRX configuration.

18. The method of claim 17, further comprising:
transmitting, to the terminal device, a radio resource control configuration indicating an index of a target SSSG.

19. The method of claim 17, further comprising:
transmitting, to the terminal device, downlink control information indicating an index of a target SSSG.

20. (canceled)

21. (canceled)

22. (canceled)
